(19) United States
(12) Patent Application Publication
(10) Pub. No.: US 2016/0356929 A1
(43) Pub. Date: Dec. 8, 2016

(54) Appellant Reply Brief [2016-08-22].pdf

(71) Applicant: Lara Knutson, New York, NY (US)

(72) Inventor: Lara Knutson, New York, NY (US)

(21) Appl. No.: 15/242,663

(22) Filed: Aug. 22, 2016

Related U.S. Application Data
(63) Continuation-in-part of application No. 13/470,944, filed on May 14, 2012.

(51) Int. Cl. G02B 5/128; G09F 13/22; G09F 13/16; G02B 5/08

(52) U.S. Cl. CPC G02B 5/128; G02B 5/0808; G09F 13/22; G09F 13/16; G09F 2013/222

(57) ABSTRACT

The present invention relates to a display device for creating a 3-D effect. The display device comprises a substrate, a first layer attached to the substrate comprising glass beads and at least one pigment, and an LED light source for shining upon the first layer.

### CROSS REFERENCE TO RELATED APPLICATIONS

This application is a continuation in part of copending application Ser. No. 13/470,944, filed May 14, 2012, and incorporated herein by reference.

### BACKGROUND OF THE INVENTION

Field of the Invention

The present invention generally relates to a display device and a method for creating a display. Specifically, the present invention relates to a method and device for creating a 3-D display effect. By using the device and method disclosed herein a display can be created heretofore unrealized results.

Description of the Related Art

Signage is widespread, yet it is often difficult to capture the attention of the typical viewer, for example, a pedestrian, driver, potential customer, or patron. Many displays have been created in order to get a viewer's attention that meet with varied success. Further, many displays have been created in order to get the attention of potential shoppers, yet these are not all successful in this regard. There is therefore a great need in the art for creating a display that effectively captures the attention of a viewer.

Accordingly, there is now provided with this invention an improved method and display device effectively overcoming the aforementioned difficulties and longstanding problems inherent in present displays. These problems have been solved in a simple, convenient, and highly effective way by which to create a display. More particularly, a 3-D effect is created by the present invention which calls attention to the display in a way not previously achieved.

### SUMMARY OF THE INVENTION

According to one aspect of the invention, a display device is disclosed. The display device comprises a reflective substrate, a first layer attached to the substrate comprising glass beads and at least one pigment, and an LED light source for shining upon the first layer and thereby creating a 3-D halo effect.

According to another aspect of the invention, a display device is disclosed. The display device comprises a substrate, a first layer attached to the substrate comprising glass beads and at least one pigment, a reflective layer interposed between the substrate and the first layer, and an LED light source for shining upon the first layer and thereby creating a 3-D halo effect.

According to yet another aspect of the invention, a method for creating a display is disclosed. The method comprises attaching a first layer to a substrate, wherein the first layer comprises glass beads and at least one pigment and shining a first light from a first LED source onto the first layer so that a 3-D halo effect occurs.

As will be appreciated by those persons skilled in the art, a major advantage provided by the present invention is creating a 3-D display device and method. Additional objects of the present invention will become apparent from the following description.

It is understood that the claimed device makes use of the phenomenon of retro-reflection, whereby light waves are reflected on a path similar to their initial path. Retroreflection in the device described in the application is accomplished through reflective microbeads embedded into a layer in the device. As a localized light source is placed in close proximity to the surface of the device, light waves from this light source are partially refracted by the beads, but largely retroreflect back towards the light source. The partial refraction causes a concentration of light surrounding the light source, generating the appearance of a floating image above the reflective surface, which the application terms a “halo”. The closer the light is placed to the surface, the more concentrated this “halo” image appears.

Embodiments of the present invention may have two or more layers, with a critical layer of reflective micro beads. Depending on the properties of the micro beads, they may be partially coated with a reflective coating to increase their reflective properties. Reflection may be further enhanced by placing a continuous layer of reflective material beneath the layer of micro beads.

The method and apparatus of the present invention will be better understood by reference to the following detailed discussion of specific embodiments and the attached figures which illustrate and exemplify such embodiments.

### DESCRIPTION OF THE DRAWINGS

A specific embodiment of the present invention will be described with reference to the following drawings, wherein:

FIG. 1 is a schematic drawing of an embodiment of the present invention.

FIG. 2 is a schematic drawing of another embodiment of the present invention.

FIG. 3 is a schematic drawing of yet another embodiment of the present invention.

FIG. 4 is a schematic drawing of the present invention illustrating the 3-D effects of illuminations at different distances.

FIG. 5 is a schematic drawing of the present invention illustrating the 3-D effect of a redirected light source.

FIG. 6 is an alternative schematic drawing of an embodiment of the present invention.

### DESCRIPTION OF THE PREFERRED EMBODIMENT

The following preferred embodiment as exemplified by the drawings is illustrative of the invention and is not intended to limit the invention as encompassed by the claims of this application. An apparatus and method for displaying a 3-D effect is disclosed herein.

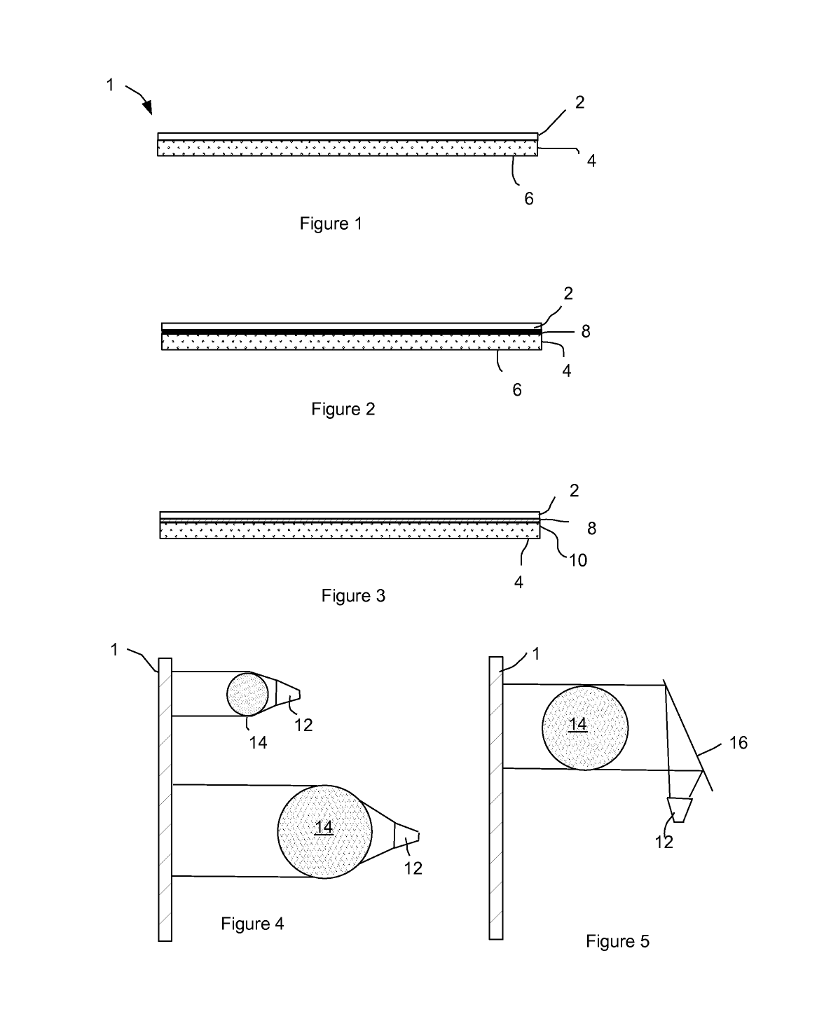

As illustrated generally in FIGS. 1-5, a display device 1 is shown. The display device, shown in FIG. 1 comprises a substrate 2 onto which a first layer 4 is positioned. The substrate illustrated in FIG. 1 is generally flat and is reflective. The substrate may be of a fairly rigid material or be somewhat flexible depending on the surface to which it is to be attached and for the particular use intended.

The first layer 4 comprises glass beads 6 and at least one pigment. The first layer may be, for example, a fabric comprising glass beads 6 and at least one pigment. The fabric may be, for example, 57% PU coagulate and 43% a polyester/cotton 48/52 textile. The glass beads may be on the fabric either as a monolayer or may, alternatively, be multilayered.

Such a fabric may be provided, for example, by I.B.R. Reflective Technologies, Via Pederzola 1/3, 24020 Scanzorosciate, Italy as described in Technical Data Sheet MI-SP20. As described therein, the fabric is a textile-reinforced polyurethane coagulate coated with a monolayer of glass. The glass has a low refractive index and typically may be in the form of microbeads. The pigment may be a metal grey shade, or alternatively, be selected from a broad color palette.

The reflective layer itself may be microbeads, for example, approximately 15% low refractive index microbeads. The microbeads may be either transparent or hemispherically aluminized. Further specifications of I.B.R. Reflective Technologies are denoted below.

| Physical Properties (*) | | Value (*) | Unit | Method (*) |
|---|---|---|---|---|
| Retroreflection | | <3 | cd/lux/m² | ITP 01-CIE 54 |
| Coeff. R (5°, 12′) | | | | |
| Weight | | 560 ± 50 | g/m² | ITP 04 |
| Thickness | | 1.0 ± 0.1 | mm | ITP 12 |
| Tensile Strength | [L/W] | >400/>400 | N/5 cm | ITP 06 |
| Break Elongation | [L/W] | <25/<35 | % | ITP 06 |
| Flexions (Bally) | | >40000 | cycles n^{o} | ITP 14 |
| Tear Strength | [L/W] | >18/>15 | N | ITP 07 |
| (trouser) | | | | |

As shown in FIG. 2, an adhesive layer 8 may be interposed between the substrate 2 and the first layer 4. The adhesive layer may be transparent or may comprise, for example, 85% adhesive and 15% pigments and additives.

As illustrated in FIG. 3, the display device may comprise a substrate 2 that is not necessarily reflective. If the substrate 2 is insufficiently reflective for creating the 3-D effect described herein, a reflective layer 10 may be interposed between the substrate and the first layer 4. The first layer may be either transparent or hemispherically aluminized microbeads. Alternatively, the reflective layer 10 itself may be created by having the microbeads be hemispherically aluminized.

FIG. 4 is a schematic drawing of the present invention illustrating the effects of illuminations at different distances. Specifically, FIG. 4 illustrates the display 1 illuminated by a light source 12 thereby forming a 3-D effect (typically a sphere effect) 14. The light source is an LED light source. The proximity of the light in relation to the reflective surface changes the light intensity and color saturation. All LED's in all forms at any wattage are effective light sources. In the instant invention, incident light is scattered from the surface in a distinct way, looking very different than similar reflective products illuminated by an LED light source.

The display may be illustrated by a single light source or by multiple light sources. The light source may be fixed or may be rotated. The light source may be monochromatic, multiple wavelengths, or white light. If more than one light source is used, they may be the same wavelength or be of different wavelengths. The light sources may be at the same distance from the display or at different distances. The light sources can be layered and colors can be mixed. Patterns can be created by layering the light sources. Depending on the intensity of the light, a corona effect is typically formed around the edge of the sphere effect 14. The brighter the light, the more solid the sphere effect appears.

As shown in FIG. 4, when the light source 12 is positioned close to the display 1, the 3-D effect 14 appears smaller than when the light source is positioned further away from the display. The light source may illuminate the display at any angle, oblique or acute. For example, the angle of incidence of the illumination from the light source onto the display may range from about 0° to 90°. The optimal angle is 90°.

FIG. 5 is a schematic drawing of the present invention illustrating the effect of a light source redirected onto the display 1. The light source of the present invention does not have to directly illuminate the display. As shown in FIG. 5, the illumination from the light source may be redirected onto the display from a reflecting surface 16. Of course, as understood by persons skilled in the art, multiple redirections of the illumination may occur before the light emanating from the light source is incident upon the display which can strike the display at any angle ranging from about 0° to 90°.

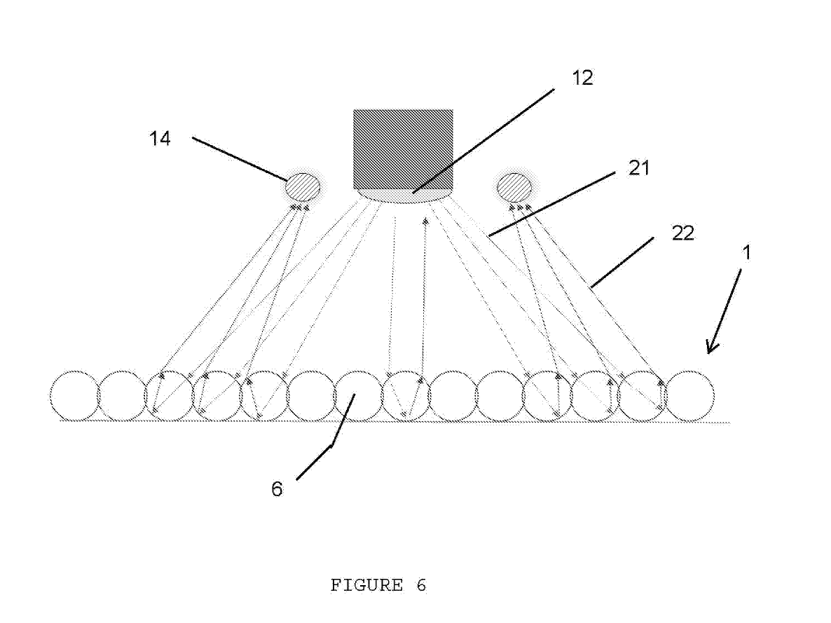

In the embodiment depicted in FIG. 6, light source 12 shines light on display 1. Incidental light, depicted by rays 21, is retroreflected at least in part through glass beads 6, depicted by rays 22, thus creating an interference pattern above display 1 that results in the appearance of image 14 above the display.

Although the particular embodiments shown and described above will prove to be useful in many applications in the advertising and other display arts to which the present invention pertains, further modifications of the present invention will occur to persons skilled in the art. All such modifications are deemed to be within the scope and spirit of the present invention as defined by the appended claims.

1. A display device, comprising:
a. a reflective substrate;
b. a first layer attached to the substrate comprising glass beads; and
c. an LED light source for shining upon the first layer and thereby creating a 3-D halo effect caused by a retroreflection pattern of light from said reflective substrate and said glass beads.

2. The display device of claim 1, further comprising an adhesive layer positioned between the substrate and the first layer.

3. The display device of claim 2, wherein the first layer is a fabric.

4. The display device of claim 3, wherein the glass beads have a low refractive index.

5. The display device of claim 4, wherein the glass beads are microbeads.

6. The display device of claim 5, wherein the fabric is coated with a monolayer of the microbeads.

7. The display device of claim 6, wherein the microbeads are transparent.

8. The display device of claim 6, wherein the microbeads are hemispherically aluminized.

9. The display device of claim 7, wherein the fabric comprises a polyester/cotton textile.

10. The display device of claim 8, wherein the fabric comprises a polyester/cotton textile.

11. A display device, comprising:
a. a substrate;
b. a first layer attached to the substrate comprising glass beads and at least one pigment;
c. a reflective layer interposed between the substrate and the first layer; and
d. an LED light source for shining upon the first layer and thereby creating a 3-D halo effect caused by a retroreflection pattern of light from said reflective substrate and said glass beads.

12. The display device of claim 11, wherein the reflective layer comprises hemispherically aluminizing the glass beads.

13. A method for creating a 3-D effect, comprising:
a. attaching a first layer to a substrate, wherein the first layer comprises glass beads and at least one pigment; and
b. shining a first light from a first LED source onto the first layer so that a 3-D halo effect occurs, said halo effect being caused by a retroreflection pattern of light from said reflective substrate and said glass beads.

14. The method of claim 13, wherein the first LED source is monochromatic.

15. The method of claim 13, wherein the first LED source has more than one wavelength.

16. The method of claim 13, further comprising a second light from a second LED source.

17. The method of claim 16, wherein the first LED source has a first wavelength and the second LED source has a second wavelength.

18. The method of claim 17, wherein the glass beads are low refractive index microbeads.

19. The method of claim 18, wherein the first layer is attached to the substrate with transparent adhesive.

20. The method of claim 19, wherein the first layer has a monolayer of the microbeads.
